(19) United States
(12) Patent Application Publication
(10) Pub. No.: US 2010/0029807 A1
(43) Pub. Date: Feb. 4, 2010

(54) METHOD FOR PRODUCING DISPERSIONS

(75) Inventors: Gerhard Jonschker, Heppenheim (DE); Matthias Koch, Wiesbaden (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent Gesellschaft, Darmstadt (DE)

(21) Appl. No.: 12/518,587

(22) PCT Filed: Nov. 16, 2007
(86) PCT No.: PCT/EP07/09935

§ 371 Date: Jun. 10, 2009

(30) Foreign Application Priority Data
Dec. 11, 2006 (DE) 10 2006 058 202.0

(51) Int. Cl. C08K 9/00

(52) U.S. Cl. 523/209; 523/205

(57) ABSTRACT

The present invention relates to a process for the preparation of an aqueous dispersion comprising at least one polymer and/or oligomer and inorganic surface-modified particles, where the polymer and/or oligomer sheathes the inorganic particles having a modified surface, to dispersions prepared using the process, and to the use thereof in paint or coating systems and as adhesives or sealants.

The present invention relates to a process for the preparation of an aqueous dispersion comprising at least one polymer and/or oligomer and inorganic surface-modified particles, where the polymer and/or oligomer sheathes the inorganic particles having a modified surface, to dispersions prepared using the process, and to the use thereof in paint or coating systems and as adhesives or sealants.

WO 2006/008120 discloses aqueous binder dispersions comprising nanoparticles which comprise nanoscale polymer particles dispersed in water or an aqueous colloidal solution which sheathe the nanoparticles. The said particles are produced by incorporating the nanoparticles into a water-free polymer phase with shear, and incorporating the resultant polymer particles containing nanoparticles into water with shear. The said production process has the disadvantage that high shear forces act on the nanoparticles and the polymer particles, which may result in detachment of the polymer sheath from the nanoparticles. Furthermore, the two-step process is very complex. In addition, only nanoparticles in the form of dry powders or water-free dispersions are suitable for incorporation into the water-free polymer phase. However, pulverulent nanoparticles are highly agglomerated and can no longer be deagglomerated completely under usual conditions (shear forces). This applies, in particular, to pyrogenic silicic acids, as used in WO 2006/008120. The preparation of water-free nanoparticle dispersions is very complex and therefore expensive. The nanoparticles must be compatibilised with the polymer and solvent phases. The introduction of reactive nanoparticles into a solvent phase favours the formation of agglomerates and crosslinked aggregates with the oligomers present therein. After conversion into an aqueous phase, it is probable that an oligomer droplet contains more than one nanoparticle. It is therefore not possible to produce defined core/shell particles using this process, but instead agglomerates comprising a plurality of nanoparticles and polymer are formed.

There is therefore a demand for alternative processes for the preparation of corresponding dispersions.

Starting herefrom, the object of the present invention was to provide alternative processes for the preparation of dispersions and corresponding dispersions which are simpler to carry out and respectively have improved properties compared with dispersions from the prior art. At the same time, the dispersion obtained should be suitable for use in painting and coating technology and in adhesive applications using conventional methods, such as rolling, spraying, brushing, curtain coating or roller coating.

This object is achieved by a process for the preparation of an aqueous dispersion comprising at least one polymer and/or oligomer (B) and inorganic surface-modified particles, where the polymer and/or oligomer (B) sheathes the inorganic particles having a modified surface, and by dispersions prepared using the process.

The process for the preparation of the dispersion according to the invention comprises the following steps:

a) preparation of a dispersion of inorganic particles in water or a water/solvent mixture and modification of the surface of the inorganic particles in the aqueous dispersion by addition of a surface modifier
b) preparation of an oligomer (A) by polymerisation of suitable monomers in a solvent or solvent mixture
c) mixing of the oligomer (A) from step b) with the aqueous dispersion from step a) and further polymerisation of the oligomer (A) to give a polymer and/or oligomer (B).

In step a) of the process according to the invention, firstly a dispersion of inorganic particles in water or a water/solvent mixture is prepared.

In an embodiment of the present invention, the preparation of the dispersion can be carried out by dispersal of inorganic particles in water or a water/solvent mixture. The dispersal is preferably carried out by stirring. Suitable solvents in the water/solvent mixture are, for example, alcohols, ketones or cyclic ethers, in particular ethanol, acetone, ethyl methyl ketone, THF or dioxane. The proportion of solvent in the water/solvent mixture can be up to 95% by weight, preferably up to 80% by weight, based on the mixture. The dispersal can be carried out at temperatures between the freezing and boiling point of the respective solvent employed, preferably at room temperature.

In addition, it is also possible, in a further embodiment of the present invention, to produce corresponding inorganic particles in water or a water/solvent mixture and to employ the resultant dispersion directly, i.e. the inorganic particles are produced directly in water or the water/solvent mixture from suitable precursors. For the production of the particles, suitable precursors are brought to reaction in water or a water/solvent mixture with formation of corresponding particles, which are then dispersed in water or the water/solvent mixture. Corresponding processes are known to the person skilled in the art and are described, for example, in U.S. Pat. No. 4,775,520 (Unger et al.; Stöber Synthesis) or Iler “The Chemistry of Silica” or Brinker/Scherer “The Sol-Gel Process”.

Particles which are suitable for the present invention are preferably selected from the group of the oxides, mixed oxides, carbides, borides and nitrides of elements from main group II to IV and/or elements from sub-group I to VIII of the Periodic Table, including the lanthanides. The inorganic particles are particularly preferably nanoparticles, in particular selected from the group comprising hydrophilic and hydrophobic, in particular hydrophilic, nanoparticles based on oxides or hydroxides of silicon, titanium, zinc, aluminium, cerium, cobalt, chromium, nickel, iron, yttrium and/or zirconium, or metals, such as, for example, Ag, Cu, Fe, Au, Pd, Pt, or alloys coated with oxides or hydroxides of silicon. The particles based on oxides or hydroxides of titanium, zinc, aluminium, cerium, cobalt, chromium, nickel, iron, yttrium and/or zirconium may optionally be coated with oxides or hydroxides of silicon. The individual oxides can also be in the form of mixtures.

The inorganic particles preferably have an average particle size, determined by means of a Malvern ZETASIZER (dynamic light scattering) or transmission electron microscope, of 3 to 200 nm, in particular 5 to 80 nm and very particularly preferably 10 to 50 nm. Particular preference is given to the use of nanoparticles, particularly preferably based on silicon dioxide, aluminium oxide, cerium oxide, zirconium oxide and/or titanium dioxide.

Examples of nanoparticles in the form of powders are silicon dioxides, for example pyrogenic silicic acids, such as Aerosil 200, Aerosil TT 600, Aerosil OX 50 and Aerosil 7200 from Degussa AG, or nanoscale silicon dioxides prepared by means of plasma processes, such as, for example, KADESIT040-100 from KDS NANO, titanium dioxides, such as pyrogenic titanium dioxide P25 from Degussa AG, or Hombitec RM 300 from Sachtleben Chemie GmbH, aluminium oxides, for example pyrogenic aluminium oxide C from Degussa AG or PureNano™ aluminium oxide from NanoProducts Corporation or NanoDur™ aluminium oxide from Nanophase Technologies Corporation, in each case prepared, for example, by means of plasma processes, in addition further nanoscale metal oxides prepared by means of physical/chemical processes, such as, for example, flame pyrolysis or plasma processes, for example cerium oxides, such as NanoTek cerium oxide from Nanophase Technologies Corporation, zirconium oxides from inocermic GmbH or NanoGard zinc oxide from Nanophase Technologies Corporation, nanoscale barium sulfates, for example Sachtoperse® HU-N from Sachtleben Chemie GmbH, phyllosilicates, for example Nanofil® 15 from Süd-Chemie AG, and nanoscale boehmites, for example Disperal from Sasol Chemical Industries Ltd.

Furthermore, it is also possible to use nanohectorites, which are marketed, for example, by Südchemie under the trade name Optigel® or by Laporte under the trade name Laponite®. Furthermore, silica sols (SiO₂ in water), prepared from ion-exchanged water-glass, are also particularly preferred.

In addition, the surface of the inorganic particles in the aqueous dispersion is modified by addition of a surface modifier in step a) of the process according to the invention. For the purposes of the present invention, modification of the surface means that compounds are bound to the surface of the inorganic particles by a covalent bond or by means of adsorptive interactions. The modification of the surface of the inorganic particles is preferably carried out by covalent bonding of the corresponding compounds to the surface. In this way, a particularly stable system comprising particles and surface modifier is produced.

Suitable surface modifiers in the broadest sense are compounds of the general formula (I)

[(S—)ₒ-L-]ₘM(R)ₙ(H)ₚ (I)

in which the indices and variables have the following meaning:
S denotes a reactive functional group;
L denotes an at least divalent organic linking group;
H denotes a hydrolysable monovalent group or hydrolysable atom;
M denotes a divalent to hexavalent main-group or sub-group metal;
R denotes a monovalent organic radical;
o denotes an integer from 1 to 5;
m+n+p denotes an integer from 2 to 6;
p denotes an integer from 1 to 6;
m and n denote zero or an integer from 1 to 5.

The group S can be selected, for example, from the group of the amino, amide, carboxyl, mercapto, isocyanato, hydroxyl, alkoxy, alkoxycarbonyl, acryloxy, methacryloxy or epoxide groups. The group L is usually an alkyl, alkenyl, aryl, alkylaryl, arylalkyl, arylalkenyl, alkenylaryl radical, preferably having in each case 1 to 12 and in particular 1 to 8 carbon atoms, where cyclic forms are included. The said radicals may be interrupted by oxygen, sulfur or nitrogen atoms or the NR″ group, where R″=hydrogen or C₁₋₄-alkyl. The group H can be any group which hydrolyses under basic or acidic conditions, for example from the class of the alkoxy groups. M is preferably Ti, Zr, Si or Al. For example, isopropyltriisostearoyl titanate or neopentyl(diallyl)oxytrineodecanoyl zirconate can be employed as surface modifier.

M is preferably =Si, i.e. the surface modifiers are selected from the group of the silanes. In this case, R is very particularly preferably selected from alkoxy groups. For the purposes of the present invention, particularly preferred alkoxysilanes conform to the general formula (II):

R′₄₋ₓSi(OR)ₓ (II)

in which the radicals R are identical to or different from one another, preferably are identical and represent optionally substituted, preferably unsubstituted, hydrocarbon groups having 1 to 8, preferably 1 to 6 and particularly preferably 1 to 4 carbon atoms. R particularly preferably denotes methyl or ethyl.

The radicals R′ may be identical to or different from one another and in each case represent an optionally substituted hydrocarbon group having 1 to 20 carbon atoms. x in formula (II) is 1, 2 or 3.

Examples of radicals R′ in the above formula (II) are alkyl, alkenyl, aryl, alkylaryl, arylalkyl, arylalkenyl, alkenylaryl radicals, preferably each having 1 to 12 and in particular 1 to 8 carbon atoms, where cyclic forms are included. The said radicals may be interrupted by oxygen, sulfur or nitrogen atoms or the NR″ group, where R″=hydrogen or C₁₋₄-alkyl. The radicals R′ preferably carry one or more substituents from the group of the halogens and the optionally substituted amino, amide, carboxyl, mercapto, isocyanato, hydroxyl, alkoxy, alkoxycarbonyl, acryloxy, methacryloxy or epoxide groups.

The above alkoxysilanes of the general formula (II) particularly preferably include at least one in which at least one radical R′ contains a group which is able to undergo a polyaddition, polymerisation or polycondensation reaction. This group which is capable of a polyaddition or polycondensation reaction is preferably an amino, diamino, polyamino, hydrazino, ketimino, hydroxyl or epoxide group. Accordingly, preferred organically modified alkoxysilanes of the general formula (II) for use as surface modifier in the present invention are, for example, those in which x is 2 or 3 and in particular 3 and a radical R′ or the single radical R′ stands for w-glycidyloxy-C₂₋₆-alkyl.

The said surface modifiers are reactive compounds which are able to react with the binder and/or the binder precursors.

The radical R′ particularly preferably contains an amino, diamino, polyamino, hydrazino or ketimino group. If the polymer and/or oligomer employed in the aqueous dispersion is a polyurethane, the said surface modifiers can react with the polymer and/or oligomer via the amino, diamino, polyamino, hydrazino or ketimino groups and in this way ensure particularly strong linking of particle and polymer.

The rapid reaction between an amino group and a terminal isocyanate group preferably present in the oligomer (A) ensures that the growth process on the particles is faster than the reaction between the isocyanate group and water. The particles can thus serve as growth centres for the polymers and are therefore structure-determining. The possibility of particle-size control of the polymer/nanoparticle dispersion thus arises. Furthermore, crosslinking of the polymer chains with one another is reduced, which reduces the viscosity of the system as a whole.

Specific examples of suitable silanes are 3-glycidoxypropyltri(m)ethoxysilane, 3,4-epoxybutyltrimethoxysilane and 2-(3,4-epoxycyclohexyl)ethyltrimethoxysilane. Further examples of suitable compounds where x=1 or 2 are 3-glycidoxypropyldimethyl(m)ethoxysilane, 3-glycidoxypropylmethyl-di(m)ethoxysilane or 3-mercaptopropyltrimethoxysilane.

Particularly suitable compounds are 3-aminopropyltriethoxysilane, N-ethyl-gamma-aminoisobutyltriethoxysilane, secondary aminosilanes (A-Link 15, Y9669, bis-gamma-triethoxysilylpropylamine, from GE Silicones) or N-butylaminopropyltrimethoxysilane, where 3-aminopropyltriethoxysilane and N-butylaminopropyltrimethoxysilane are very particularly preferably employed as surface modifier.

In step b) of the process according to the invention, an oligomer (A) is prepare by polymerisation of suitable monomers in a solvent or solvent mixture. The oligomer (A) preferably contains terminal isocyanate groups, epoxide groups and optionally groups which can be polymerised by means of free radicals. Furthermore, the oligomer (A) obtained in step b) may contain radiation-curable groups. Suitable for this purpose are UV/VIS, α-, γ-electron beams or other high-energy rays. However, it is also possible for the aqueous dispersion to comprise a non-radiation-curing polymer and/or oligomer, for example one which dries in air, under force conditions or under baking conditions, which can be used both in one-component and multicomponent coating compositions and may optionally comprise solvents. The oligomer (A) particularly preferably also contains ionic groups, precursors of ionic groups, for example carboxylic acids, and/or amphiphilic groups.

The oligomers (A) typically consist of polyethers, polyesters, polyureas or polyurethanes. Polyacrylates are also possible. The added oligomer (A) is preferably selected from the class of the terminally isocyanate-modified polyurethanes/polyureas, for example as polyurethane prepolymers, as capped prepolymers or as fully reacted polyurethanes in the form of a melt or solution/dispersion. In this case, for example, polyisocyanates and polyols are suitable as precursors for the oligomer (A). Examples of common precursors which are suitable for the preparation of corresponding polyurethane polymers include, for example, HDI (hexamethylene diisocyanate), IPDI (isophorone diisocyanate), diols, 2,2′-dimethylolpropionic acid, aminosulfonates, hydroxysulfonates, HEMA ((2-hydroxyethyl)methacrylate). In addition to these known components, silanes, such as, for example, aminosilanes or hydroxyl-functional silanes, can also be incorporated into the polyurethane prepolymer. A preferred embodiment consists in that the polyurethane prepolymer also contains UV-curable groups, for example by copolymerisation of HEMA or maleic/fumaric acid derivatives into the prepolymer.

The preparation of the polymers and/or oligomers (A) can be carried out catalytically or with thermal induction. In the simplest embodiment, the oligomers (A) are prepared catalytically. Suitable catalysts are, for example, organic tin compounds, such as dibutyltin dilaurate, or metal salts of ethylhexanoic acid, such as, for example, zinc ethylhexanoate. All methods known to the person skilled in the art for the preparation of polyesters, polyethers, polyurethanes, polyureas, or mixtures/blends can be employed in the step according to the invention. The reaction time in the preparation of the oligomers (A) in step b) of the process according to the invention is usually a few minutes to several hours.

In step c) of the process according to the invention, the oligomer (A) from step b) and the aqueous dispersion from step a) are mixed, and the polymer and/or oligomer (B) is prepared by further polymerisation of the oligomer (A).

In the simplest embodiment of the process according to the invention, the oligomer (A) obtained in step b) and the dispersion obtained from step a) are mixed. In the simplest case, this is carried out by simple stirring-in of the corresponding oligomer (A), for example through the use of shear forces. The amount of oligomer (A) here is selected so that the proportion of oligomer (A) in the aqueous dispersion is 5 to 70% by weight. pH-adjusting agents and further suitable reaction partners for the oligomer (A) can optionally be added beforehand, afterwards or at the same time. In particular due to the addition of further reaction partners, the oligomer (A) can be converted further into the polymer and/or oligomer (B). A polymer/oligomer (B) thus forms which can then be crosslinked further by UV radiation. In principle, all types of polymerisation known to the person skilled in the art are suitable, with the preparation of the polymer and/or oligomer (B) preferably being carried out by a polyaddition, polycondensation or by anionic polymerisation in solution.

In the case of the polyurethanes preferably employed in accordance with the invention, the precursors already employed in the preparation of the oligomers (A) can be employed for the preparation of the corresponding polymers and/or oligomers (B).

In further embodiments of the process according to the invention, it is possible to adjust the solids content by removal of any residual solvent from the reaction mixture and prior, subsequent or simultaneous addition of water. Finally, the pH can optionally be finally adjusted and a filtration (removal of any agglomerates occurring) can optionally be carried out.

The present invention likewise relates to aqueous dispersions comprising at least one polymer and/or oligomer (B) and inorganic surface-modified particles, where the polymer and/or oligomer (B) sheathes the inorganic surface-modified particles, obtainable by a process according to the present invention. The surface modifiers are preferably covalently bonded to the surface of the particles. In this way, the surface-modified inorganic particles can be bound in a more stable manner into the polymer and/or oligomer (B) to be prepared in the final step of the process according to the invention since the reactive groups present in the surface modifier are able to react with the polymer and/or oligomer precursors.

Compared with the dispersions prepared in accordance with WO 2006/008120, the dispersions according to the invention have the advantage that water-based nanoparticle dispersions can be employed and the difficult conversion of the particles into solvent-based dispersions can be omitted. Furthermore, the nanoparticles act as nucleating agents and structure formers for the growing polymers. Control of the particle size of the dispersions is thereby possible. Since no deagglomeration of the particles is necessary, the dispersion can be prepared under milder conditions (lower shear forces). The viscosity is lower due to the use of non-agglomerated or non-aggregated particles. Pre-crosslinking of polymers and particles in the solvent phase is avoided. Furthermore, the formation of polymer droplets which contain only one nanoparticle as core is favoured. The covalent bonding and the “burying” of the inorganic nanoparticles under the polymer sheath prevent compatibility problems and effectively protect the nanoparticles against further agglomeration.

The polymer and/or oligomer (B) in the dispersion according to the invention preferably has a molecular weight of at least 500 g/mol, particularly preferably at least 800 g/mol to max. 500,000 g/mol. In the case where the polymer/oligomer (B) is a polyurethane, the molecular weight is preferably between 5000 and 50,000 g/mol.

In the aqueous dispersions according to the invention, the polymer particles preferably have an average particle diameter of between 20 and 500 nm, particularly preferably between 30 and 200 nm. The nanoparticles which are present in the polymer particles must, since they are sheathed by the polymer of the polymer particle, have a smaller particle diameter than the polymer particles themselves.

The aqueous dispersion in accordance with the present invention preferably comprises 5 to 70% by weight, preferably 5 to 60% by weight, of polymer particles containing nanoparticles, based on the composition as a whole.

In a preferred embodiment, the aqueous dispersion comprises protective colloids and/or emulsifiers, in particular surfactants, amphiphiles or acids or bases, for example tert-amines, aminoalcohols or ammonia, as additives, as corresponding counterions for the emulsification of ionic polymers or oligomers. Suitable emulsifiers are saturated and unsaturated fatty alcohol ethoxylates having 8 to 15 C atoms in the fatty alkyl radical, alkylphenol ethoxylates having 6 to 13 C atoms in the alkyl radical and 4 to 100 ethylene oxide units, preferably lauryl alcohol ethoxylates, isotridecanol ethoxylates and octyl- and nonylphenol ethoxylates having 6 to 50 ethylene oxide units.

Also highly suitable are mixtures of such emulsifiers comprising a hydrophilic component and a hydrophobic component in the ratio 1:5 to 5:1, for example comprising one part of lauryl alcohol 4 EO and three parts of lauryl alcohol 40 EO. The emulsifiers are employed in a total amount of 0 to 15% by vol. of the dispersion, preferably 0.8 to 10% by vol. of the dispersion. Highly suitable emulsifiers are also esters and ethoxylated esters of sorbitan, as available under the trade names Tween and Span, preferably Tween 20 and Span 60 in the ratio 1:1 to 1:7% by weight. 3 to 15% by weight of the hydrophobic emulsifier are particularly preferably replaced by oleyl sarcoside. The resultant dispersions are storage-stable, without sedimentation and without change to the particle-size distribution. The protective colloids and/or emulsifiers are preferably employed here in an amount of 0.1 to 10% by weight, based on the dispersion as a whole.

Preferred additives used in the aqueous dispersion are catalysts, cocatalysts, free-radical formers, photoinitiators, photosensitisers, hydrophobicising agents, matting agents, lubricants, antifoams, deaerators, wetting agent, flow-control agents, thixotropic agents, thickeners, inorganic and organic pigments, fillers, adhesion promoters, corrosion inhibitors, UV stabilisers, free-radical scavengers, antistatics and/or wetting agents. Additionally preferred additives are water-soluble monomers which can be polymerised thermally and/or by means of high-energy radiation, preferably (meth)acrylic acid, (meth)acrylamide, hydroxyethyl(meth)acrylate, vinylphosphonic acid and vinylsulfonic acid.

It is furthermore preferred for the additives employed to be esters of meth(acrylic acid) containing branched and/or linear C₁-C₁₆-alkyl radicals.

The aqueous dispersion preferably has a viscosity in the range from 1 to 800 mPas at 20° C.

The aqueous dispersions according to the invention are used as paint and coating compositions or as adhesives and sealants. They are preferably employed for the production of scratch- and abrasion-resistant and adhesive layers, layers having increased chemical or mechanical resistance and/or barrier layers. Nanoparticle-containing surface coatings of the present invention have improved gloss retention (Example 2) and are thus more scratch-resistant. The present invention likewise relates to paint and coating compositions or adhesives and sealants comprising dispersions in accordance with the present invention.

The subject-matter of the application will be explained in greater detail with reference to the following examples, without restricting it to the specific embodiments mentioned here.

### EXAMPLES

### Example 1a

### Preparation of a PU Dispersion as Reference

131.3 g of Oxyester T 1136, 20.52 g of dimethylolpropionic acid, 17.48 g of 1,4-cyclohexanedimethanol, 149 g of N-methylpyrrolidone and 0.03 g of dibutyltin dilaurate are introduced into a four-necked flask flushed with inert gas, and warmed to 85° C. with stirring. 162.11 g of Desmodur W (Bayer, Germany) are slowly added dropwise to the mixture, which is subsequently stirred for a further 4 h. The prepolymer solution cooled to 50-60° C. is transferred into a stainless-steel dissolver vessel and stirred with high shear forces. 13.14 g of triethylamine and 105 g of deionised water are subsequently added rapidly to the mixture.

In a separate vessel, 18.53 g of 2-methylpentamethylenediamine and 382 g of deionised water are mixed and slowly added to the mixture with constant stirring.

The entire mixture is mixed further for 20 minutes with high shear forces. The resultant PU dispersion is filtered through a 280 μm fast sieve and has a pH of 8.5 and a solids content of 41.5%.

The dispersion is applied to black/white paint cards using a 200 μm hand coater and dried at 80° C. for 30 min.

### Example 1b

### Preparation of a Nanoparticle Dispersion

3 g of Dynasilan 1151 (aminosilane hydrolysate, aqueous, product from Degussa) are added with vigorous stirring to 100 g of Levasil 200 S silica sol, and the pH is adjusted to about 3 using formic acid.

### Example 2

### Synthesis of a Nanoparticle-Modified PU Dispersion

131.3 g of Oxyester T 1136, 20.52 g of dimethylolpropionic acid, 17.48 g of 1,4-cyclohexanedimethanol, 149 g of N-methylpyrrolidone and 0.03 g of dibutyltin dilaurate are introduced into a four-necked flask flushed with inert gas, and warmed to 85° C. with stirring. 162.11 g of Desmodur W (Bayer, Germany) are slowly added dropwise to the mixture, which is subsequently stirred for a further 4 h. The prepolymer solution cooled to 50-60° C. is transferred into a stainless-steel dissolver vessel and stirred with high shear forces. 13.14 g of triethylamine and 126 g of a 20% dispersion of aminopropyltrimethoxysilane-modified SiO₂ nanoparticles (comprising 2% by weight of aminosilane, based on the dry mass) in deionised water are subsequently added rapidly to the mixture.

In a separate vessel, 18 g of 2-methylpentamethylenediamine and 382 g of deionised water are mixed and slowly added to the mixture with constant stirring.

The entire mixture is mixed further for 20 minutes with high shear forces. The resultant PU dispersion is filtered through a 280 μm fast sieve and has a pH of 8.5 and a solids content of 41.5%.

The dispersion is applied to black/white paint cards using a 200 μm hand coater and dried at 80° C. for 30 min.

After application and drying on the paint cards, the paints were measured using a commercially available glossmeter (Byk-Gardner) at a specular angle of 20° and subsequently subjected to a scratch test. To this end, abrasive paper with a grain size of 9 μm (3M) was applied to the finger of a crockmeter, and 10 double strokes were applied at a load of 9 N. The gloss after scratching was then re-measured.

| | 0% | 5% | 10% | Nanoparticles |
|---|---|---|---|---|
| Beforehand | 83 | 82 | 81 | gloss units |
| Afterwards | 11 | 21 | 28 | gloss units |

1. Process for the preparation of an aqueous dispersion comprising at least one polymer and/or oligomer (B) and inorganic surface-modified particles, comprising the process steps of
a) preparation of a dispersion of inorganic particles in water or a water/solvent mixture and modification of the surface of the inorganic particles in the aqueous dispersion by addition of a surface modifier
b) preparation of an oligomer (A) by polymerisation of suitable monomers in a solvent or solvent mixture
c) mixing of the oligomer (A) from step b) with the aqueous dispersion from step a) and further polymerisation of the oligomer (A) to give a polymer and/or oligomer (B),
where the polymer and/or oligomer (B) sheathes the inorganic particles having a modified surface prepared in step a).

2. Process according to claim 1, characterised in that, in step a), the dispersion of inorganic particles in water or a water/solvent mixture is prepared by dispersal of inorganic particles in water or a water/solvent mixture.

3. Process according to claim 1, characterised in that, in step a), the inorganic particles are produced directly in water or the water/solvent mixture from suitable precursors.

4. Process according to claim 1, characterised in that the polymer and/or oligomer (B) from step c) is prepared by addition of suitable polymer and/or oligomer precursors to the mixture of surface-modified particles and oligomer (A) obtained in step c).

5. Process according to claim 1, characterised in that the oligomer (A) and the polymer and/or oligomer (B) are prepared by anionic polymerisation, polycondensation or polyaddition.

6. Process according to claim 1, characterised in that the oligomer (A) is selected from the class of the polyurethanes, polyureas, polyesters or polyethers.

7. Process according to claim 1, characterised in that any residual solvents are removed from the reaction mixture, the solids content is adjusted by prior, subsequent or simultaneous addition of water, the pH of the dispersion is adjusted and/or the mixture is optionally filtered.

8. Aqueous dispersion comprising at least one polymer and/or oligomer (B) and inorganic surface-modified particles, where the polymer and/or oligomer (B) sheathes the inorganic surface-modified particles, obtainable by a process according to claim 1.

9. Aqueous dispersion according to claim 8, characterised in that the polymer and/or oligomer (B) has a molecular weight of at least 500 g/mol to max. 500,000 g/mol.

10. Aqueous dispersion according to claim 8, characterised in that the polymer and/or oligomer (B) is a polyurethane, polyester or polyether whose molecular weight is between 5000 and 50,000 g/mol.

11. Aqueous dispersion according to claim 8, characterised in that the inorganic particles are selected from the group of the oxides, mixed oxides, carbides, borides and nitrides of elements from main group II to IV and/or elements from sub-group I to VIII of the Periodic Table, including the lanthanides.

12. Aqueous dispersion according to claim 8, characterised in that the inorganic particles are selected from the group comprising hydrophilic and hydrophobic particles based on oxides or hydroxides of silicon, titanium, zinc, aluminium, cerium, cobalt, chromium, nickel, iron, yttrium and/or zirconium, or metals coated with oxides or hydroxides of silicon.

13. Aqueous dispersion according to claim 12, characterised in that the inorganic particles based on oxides or hydroxides of titanium, zinc, aluminium, cerium, cobalt, chromium, nickel, iron, yttrium and/or zirconium are coated with oxides or hydroxides of silicon.

14. Aqueous dispersion according to claim 8, characterised in that the inorganic particles have an average particle size, determined by means of a Malvern ZETASIZER (dynamic light scattering) or transmission electron microscope, of 3 to 200 nm.

15. Aqueous dispersion according to claim 8, characterised in that the inorganic particles are nanoparticles based on silicon dioxide, aluminium oxide, cerium oxide, zirconium oxide and/or titanium dioxide.

16. Aqueous dispersion according to claim 8, characterised in that the inorganic particles are surface-modified with compounds of the general formula (I)
[(S—)ₒ-L-]ₘM(R)ₙ(H)ₚ (I),
in which the indices and variables have the following meaning:
S denotes a reactive functional group;
L denotes an at least divalent organic linking group;
H denotes a hydrolysable monovalent group or hydrolysable atom;
M denotes a divalent to hexavalent main-group or sub-group metal;
R denotes a monovalent organic radical;
o denotes an integer from 1 to 5;
m+n+p denotes an integer from 2 to 6;
p denotes an integer from 1 to 6;
m and n denote zero or an integer from 1 to 5.

17. Aqueous dispersion according to claim 8, characterised in that the inorganic particles are surface-modified with compounds of the general formula (II)
R′₄₋ₓSi(OR)ₓ (II),
in which the radicals R are identical to or different from one another and represent substituted or unsubstituted hydrocarbon groups having 1 to 8 carbon atoms, and R′ denotes alkyl, alkenyl, aryl, alkylaryl, arylalkyl, arylalkenyl, alkenylaryl radicals, each having 1 to 12 carbon atoms, where cyclic forms are included, and in which x=1, 2 or 3.

18. Aqueous dispersion according to claim 17, characterised in that the radicals R′ contain one or more substituents from the group of the halogens and the amino, amide, carboxyl, mercapto, isocyanato, hydroxyl, alkoxy, alkoxycarbonyl, acryloxy, methacryloxy or epoxide groups.

19. Aqueous dispersion according to claim 8, characterised in that the dispersion comprises catalysts, cocatalysts, free-radical formers, photoinitiators, photosensitisers, hydrophobicising agents, matting agents, lubricants, antifoams, deaerators, wetting agents, flow-control agents, thixotropic agents, thickeners, inorganic and organic pigments, fillers, adhesion promoters, corrosion inhibitors, UV stabilisers, free-radical scavengers, antistatics and/or wetting agents.

20. A paint or coating compositions or an adhesives or sealant comprising an aqueous dispersion according to claim 8.

21. A method for the production of scratch- and abrasion-resistant and adhesive layers, layers having increased chemical or mechanical resistance and/or increased UV light and/or weathering resistance and/or barrier layers comprising using an aqueous dispersion according to claim 8.

22. Paint and coating compositions, adhesives and sealants comprising aqueous dispersions according to claim 8.
